(19) United States
(12) Patent Application Publication
(10) Pub. No.: US 2021/0390336 A1
(43) Pub. Date: Dec. 16, 2021

(54) METHOD FOR OPTIMIZING SELECTION OF SUITABLE NETWORK MODEL, APPARATUS ENABLING SELECTION, ELECTRONIC DEVICE, AND STORAGE MEDIUM

(71) Applicant: HON HAI PRECISION INDUSTRY CO., LTD., New Taipei (TW)

(72) Inventors: Wan-Jhen Lee, New Taipei (TW); Tung-Tso Tsai, New Taipei (TW); Chin-Pin Kuo, New Taipei (TW); Tzu-Chen Lin, New Taipei (TW); Guo-Chin Sun, New Taipei (TW)

(21) Appl. No.: 17/335,698

(22) Filed: Jun. 1, 2021

(30) Foreign Application Priority Data
Jun. 15, 2020 (CN) 202010544957.8

(51) Int. Cl. G06K 9/62; G06N 3/08

(52) U.S. Cl. CPC G06K 9/6227; G06K 9/6228; G06N 3/08; G06K 9/6262; G06K 9/6201

(57) ABSTRACT

A method for automatically selecting a suitable network model for machine deep learning includes identifying a category of an input content and selecting a training set based on the identified category. Several matched network models are selected based on the identified category. A test network model is selected based on performance data corresponding to the matched network models, and the selected model is trained based on the input content and the selected training set. When an output result in a display interface is not satisfactory, an optimization operation is executed for adjusting the structure of the test network model. An apparatus, an electronic device, and a storage medium applying the method are also disclosed.

### FIELD

The subject matter herein generally relates to network model selecting.

### BACKGROUND

Machine learning technology can improve performance based on collected texts and pictures, and can be applied to a data acquisition domain, an image classification domain, a language processing domain, and a robot domain. A network model can classify, detect, segment, and monitor specified targets in the pictures or the video. The network model with different parameters and training set can output different results based on input of same content. While selecting the network model, the same content is inputted to network models randomly selected by user, and the users select one of the randomly selected network models based on the output, this creates a heavy workload and is time-consuming.

Thus, there is room for improvement in the art.

### BRIEF DESCRIPTION OF THE FIGURES

Implementations of the present disclosure will now be described, by way of example only, with reference to the attached figures.

FIG. 1 is a flowchart illustrating an embodiment of method for optimizing the selection of a suitable network model.

FIG. 2 is a detailed flowchart illustrating the block 15 of the method of FIG. 1.

FIG. 3 is a detailed flowchart illustrating the block 16 of the method of FIG. 1.

FIG. 4 is a diagram illustrating an embodiment of a network model optimization apparatus.

FIG. 5 is a diagram illustrating an embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

The present disclosure provides a method for optimizing the selection of a suitable network model.

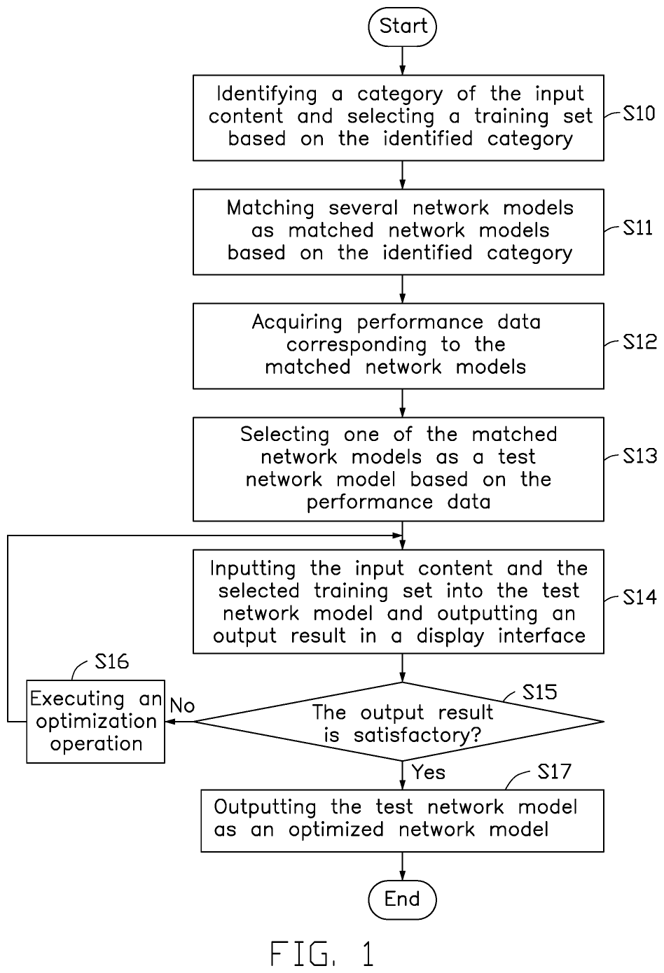

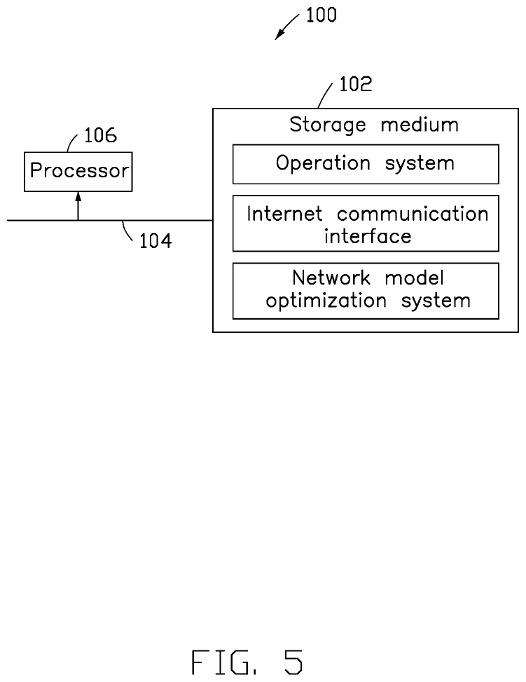

FIG. 1 shows a flowchart of a method for the above. The method is used in at least one electronic device 100 (as shown in FIG. 5) and at least one server (not shown). The electronic device 100 provides a visible interface for establishing a communication between user and the electronic device 100 by a terminal device, such as a mobile device or a computer. Data between the electronic device 100 and the at least one server is transmitted by a specified protocol. In one embodiment, the specified protocol can be a Hyper Text Transfer Protocol (HTTP), or a Hyper Text Transfer Protocol over Secure Socket Layer (HTTPS), but not being limited thereto. In one embodiment, the server can be a single server, or can be a group of servers having different functions. The electronic device 100 can be a movable terminal with a networking function, such a personal computer, a tablet, a smart phone, a personal digital assistant (PDA), a game machine, an internet protocol television (IPTV), a smart wearable device, or a navigator. The electronic device 100 can be a fixed terminal with a networking function, such as an outdoor billboard, a desktop computer, or a digital television. In one embodiment, the electronic device 100 includes a storage medium 102 (as shown in FIG. 5). The storage medium 102 can store categories and training sets. The method automatically selects several network models, and, based on performance data, selects one of the selected network models as a test network model. A specified content is inputted into the test network mode, and an output result corresponding to the test network model is outputted. A manner of optimization is selected based on the output result. The method may comprise at least the following blocks, which also may be re-ordered:

In block 10, a category of the input content is identified, and a training set is selected based on the identified category in response to a processing command.

In one embodiment, the category can be a classify category, a detection category, and a segment category.

In block 11, several network models are matched as matched network models based on the identified category, in response to a matching command.

In one embodiment, the matched network models can be local network models, and also can be on-line network models found on a network. The matched network models can be searched for by key words. The matched network models can be a convolutional neural network (CNN), such as an AlexNet model, a Visual Geometry Group (VGG) network model, a GoogLeNet, and a ResNet model.

In block 12, performance data corresponding to the matched network models are acquired in response to an acquiring command.

In one embodiment, the performance data can include a processing speed, an output result accuracy, and a size of the matched network model, not being limited thereto.

In block 13, one of the matched network models is selected as a test network model based on the performance data, in response to the selection command.

In one embodiment, the test network model can also be selected based on user's requirement. For example, when a higher processing speed is required, the matched network model with a highest processing speed can serve as the test network model. When a higher accuracy is required, the matched network model with a highest accuracy can serve as the test network model.

In block 14, the input content and the selected training set are inputted into the test network model and an output result is displayed in a display interface, in response to a training command.

In one embodiment, each training set can include a plurality of images or videos. The output result is the images, the targets in each of which being marked with different labels. The labels can be text, frames, and edge contours, but not being limited thereto. For example, when the category of the input content is a classify category, the targets in the images are marked with the text labels. When the category of the input content is a detection category, the targets in the images are marked with the frame labels. When the category of the input content is a segment category, the targets in the images are marked with the edge contours labels.

In block 15, whether the output result is satisfactory is determined in response to the determining command.

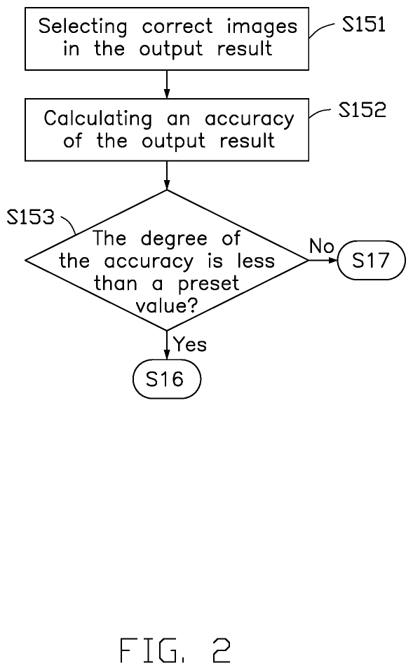

FIG. 2 shows a detail flowchart of the block 15. The block of determining in response to the determining command whether the output result is satisfactory further comprises:

In block 151, correct images in the output result are selected.

In block 152, an accuracy of the output result is calculated.

In block 153, whether the degree of accuracy is less than a preset value is determined.

When the accuracy is less than the preset value, the output result is considered not satisfactory, the procedure goes to block 16.

When the accuracy is equal to or more than the preset value, the output result is deemed satisfactory, the procedure goes to block 17.

In one embodiment, the operations of selecting the correct images are executed by a user click operation.

In block 16, an optimization operation is executed.

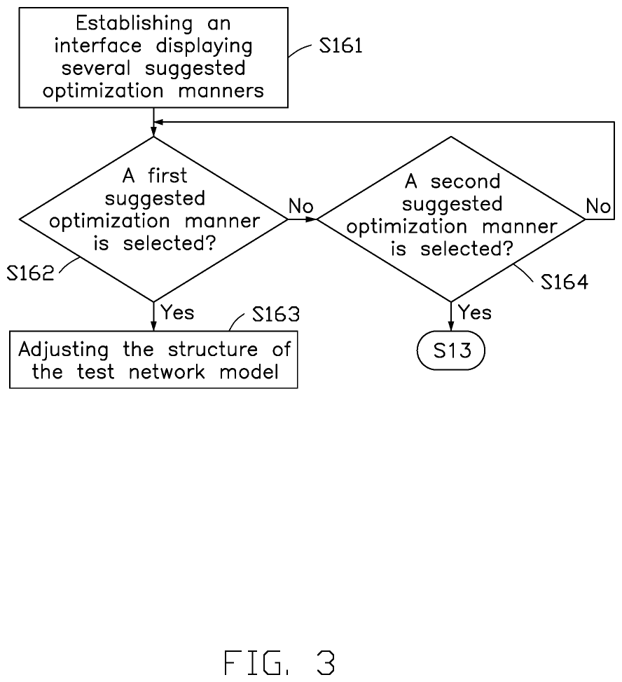

FIG. 3 shows a detailed flowchart of the block 16. In one embodiment, the optimization operation being executed further comprises:

In block 161, an interface displaying several suggested optimization manners is established.

In block 162, a determination of a first suggested optimization manner being selected is made.

In block 163, when the first suggested optimization manner is selected, the structure of the test network model is adjusted.

In block 164, when the first suggested optimization manner is not selected, a determination is made as to whether a second suggested optimization manner is made.

When the second suggested optimization manner is selected, the test network model needs to be re-selected, and the procedure returns to block 13.

When the second suggested optimization manner is not selected, the procedure returns to block 162.

In one embodiment, the structure of the test network model is adjusted by optimizing learning strategy, or by changing a number of neural network layers, or by changing a number of convolution layers, or by changing functions, not being limited thereto.

In block 17, the test network model is outputted as an optimized network model, in response to an output command.

In one embodiment, all commands can be inputted by the terminal device. The terminal device can include a keyboard and a touch screen, not being limited. The commands can be inputted by operations on the visible interface. The operations can be sliding operations or click operations (such as a single click or double-click) on keys in the visible interface. In detail, the keys can be mechanical keys or virtual keys, but not limited thereto.

Based on the above method, the network modes are firstly selected according to performance data, the output result is visible, the optimization manner can be selected by the user invoking automatic selection and optimization of the network model, thus a time for selecting the network model is reduced and the performance of the network model is improved.

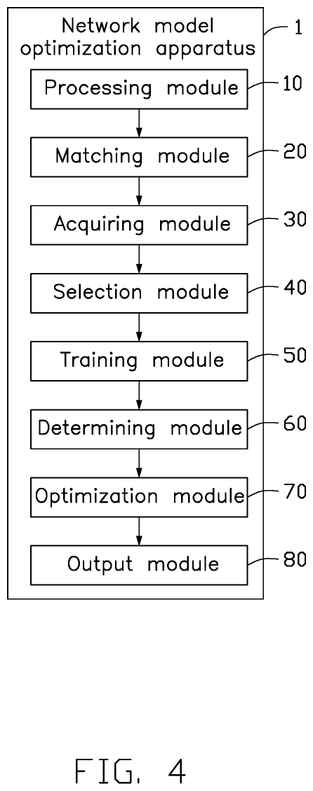

FIG. 4 shows a network model optimization apparatus 1. In one embodiment, the network model optimization apparatus 1 is used in a network model optimization system with at least one electronic device 100 (as shown in FIG. 5) and at least one server (not shown). Data between the electronic device and the at least one server is transmitted by a specified protocol.

In one embodiment, the network model optimization apparatus 1 can include one or more modules. The one or more modules are stored in a storage medium 102 (as shown in FIG. 5) and can be implemented by at least one processor 106 (as shown in FIG. 5) for executing an optimizing function.

In one embodiment, the network model optimization apparatus 1 includes the following modules:

A processing module which identifies a category of an input content and selects a training set based on the identified category, in response to a processing command.

In one embodiment, the category can be a classify category, a detection category, and a segment category.

A matching module 20 matches several network models as matched network models based on the identified category, in response to a matching command.

In one embodiment, the matched network models can be local network models, and also can be on-line network models found on a network. The matched network models can be searched for by key words. The matched network models can be a convolutional neural network (CNN), such as an AlexNet model, a Visual Geometry Group (VGG) network model, a GoogLeNet, and a ResNet model.

An acquiring module 30 acquires performance data corresponding to the matched network models, in response to an acquiring command.

In one embodiment, the performance data can include a processing speed, an output result accuracy, and a size of the matched network model, not being limited thereto.

A selection module 40 selects one of the matched network models as a test network model, based on the performance data in response to the selection command.

In one embodiment, the test network model can also be selected based on user's requirement. For example, when a higher processing speed is required, the matched network model with a highest processing speed can serve as the test network model. When a higher accuracy is required, the matched network model with a highest accuracy can serve as the test network model.

A training module 50 inputs the input content and the selected training set into the test network model and outputs an output result displayed in a display interface, in response to a training command.

In one embodiment, each training set can include a plurality of images or videos. The output result is the images, the targets in each of which being marked with different labels. The labels can be text, frames, and edge contours, not being limited thereto. For example, when the category of the input content is a classify category, the targets in the images are marked with the text labels. When the category of the input content is a detection category, the targets in the images are marked with the frame labels. When the category of the input content is a segment category, the targets in the images are marked with the edge contours labels.

A determining module 60 determines whether the output result is satisfactory in response to the determining command.

The determining module 60 further selects correct images in the output result and calculates an accuracy of the output result. The determining module 60 further determines whether the degree of accuracy is less than a preset value. When the accuracy is less than the preset value, the output result is considered not satisfactory. When the accuracy is equal to or more than the preset value, the output result is considered satisfactory.

In one embodiment, the operations to select the correct images are executed by a click operation by the user.

An optimization module 70 executes an optimization operation when the accuracy is less than the preset value.

The optimization module 70 further establishes an interface for display several suggested optimization manners, and determines whether one of the suggested optimization manners is selected.

When the first suggested optimization manner is selected, optimization module 70 adjusts the structure of the test network model.

When the second suggested optimization manner is selected, the selection module 40 re-selects one of the matched network modes as the test network model.

In one embodiment, the structure of the test network model is adjusted by optimizing learning strategy, or by changing a number of neural network layers, or by changing a number of convolution layers, or by changing functions, not being limited thereto.

In response to an output command, an output module 80 outputs the test network model as an optimized network model.

Based on the above network model optimization apparatus 1, the network modes are firstly selected by the performance data, the output result is visible, the optimization manner can be selected by the user requirement for automatically selecting and optimizing the network model, thus a time for selecting the network model is reduced and the performance of the network model is improved.

FIG. 5 shows an electronic device 100. The electronic device 100 includes at least one storage medium 102, a data bus 104, and at least one processor 106.

The at least one storage medium 102 stores program codes. The at least one storage medium 102 can be an embedded circuit having a storage function, such as memory card, trans-flash card, smart media card, secure digital card, and flash card, and so on. The at least one storage medium 102 exchanges data with the at least one processor 106 through the data bus 104. The at least one storage medium 102 stores an operation system, an internet communication interface, and the network model optimization program. The operation system manages and controls hardware and programs of software. The operation system further supports operations of other software and programs. The internet communication interface establishes communications between the members in the at least one storage medium 102, and communications between the hardware and the software in the electronic device 100.

The at least one processor 106 can be a micro-processor, or a digital processor. The at least one processor 106 is used for running the program codes stored in the at least one storage device 102 to execute different functions. The modules in FIG. 4 are program codes stored in the at least one storage medium 102 and are implemented by the at least one processor 106 for executing the method for optimizing the network model. The at least one processor 106 can be a central processing unit (CPU), or a large scale integrated circuit, being an operating core and a control core.

The at least one processor 106 executes commands stored in the at least one storage device 102 to perform the method. The commands executed by the processor 106 perform the following blocks:

In block 10, a category of the input content is identified, and a training set is selected based on the identified category in response to a processing command.

In one embodiment, the category can be a classify category, a detection category, and a segment category.

In block 11, several network models are matched as matched network models based on the identified category, in response to a matching command.

In one embodiment, the matched network models can be local network models, and also can be on-line network models found on a network. The matched network models can be searched for by key words. The matched network models can be a convolutional neural network (CNN), such as an AlexNet model, a Visual Geometry Group (VGG) network model, a GoogLeNet, and a ResNet model.

In block 12, performance data corresponding to the matched network models are acquired in response to an acquiring command.

In one embodiment, the performance data can include a processing speed, an output result accuracy, and a size of the matched network model, not being limited thereto.

In block 13, one of the matched network models is selected as a test network model based on the performance data in response to the selection command.

In one embodiment, the test network model can also be selected based on user's requirement. For example, when a higher processing speed is required, the matched network model with a highest processing speed can serve as the test network model. When a higher accuracy is required, the matched network model with a highest accuracy can serve as the test network model.

In block 14, the input content and the selected training set are inputted into the test network model and an output result is displayed in a display interface in response to a training command.

In one embodiment, each training set can include a plurality of images or videos. The output result is the images, the targets in each of which being marked with different labels. The labels can be text, frames, and edge contours, not being limited thereto. For example, when the category of the input content is a classify category, the targets in the images are marked with the text labels. When the category of the input content is a detection category, the targets in the images are marked with the frame labels. When the category of the input content is a segment category, the targets in the images are marked with the edge contours labels.

In block 15, whether the output result is satisfactory is determined in response to the determining command.

FIG. 2 shows a detail flowchart of the block 15. The block of determining whether the output result is satisfactory is determined in response to the determining command further comprising:

In block 151, correct images in the output result are selected.

In block 152, an accuracy of the output result is calculated.

In block 153, whether the degree of accuracy is less than a preset value is determined.

When the accuracy is less than the preset value, the output result is considered not satisfactory, the procedure goes to block 16.

When the accuracy is equal to or more than the preset value, the output result is deemed satisfactory, the procedure goes to block 17.

In one embodiment, the operations of selecting the correct images are executed by a user click operation.

In block 16, an optimization operation is executed.

FIG. 3 shows a detailed flowchart of the block 16. In one embodiment, the optimization operation being executed further comprises:

In block 161, an interface displaying several suggested optimization manners is established.

In block 162, a determination of whether a first suggested optimization manner is selected is made.

In block 163, when the first suggested optimization manner is selected, the structure of the test network model is adjusted.

In block 164, when the first suggested optimization manner is not selected, a determination of whether a second suggested optimization manner is made.

When it is determined that the second suggested optimization manner is selected, the test network model needs to be re-selected, and the procedure returns to block 13.

When it is determined that the second suggested optimization manner is not selected, the procedure returns to block 162.

In one embodiment, the structure of the test network model is adjusted by optimizing learning strategy, or by changing a number of neural network layers, or by changing a number of convolution layers, or by changing functions, not being limited thereto.

In block 17, the test network model is outputted as an optimized network model in response to an output command.

In one embodiment, all commands can be inputted by the terminal device. The terminal device can include a keyboard and a touch screen, not being limited. The commands can be inputted by operations on the visible interface. The operations can be sliding operations or click operations (such as a single click or double-click) on keys in the visible interface. In detail, the keys can be mechanical keys or virtual keys, not being limited thereto.

Based on the above electronic device 100, the network modes are firstly selected by the performance data, the output result is visible, the optimization manner can be selected by the user requirement for automatically selecting and optimizing the network model, thus a time for selecting the network model is reduced and the performance of the network model is improved.

While various and preferred embodiments have been described the disclosure is not limited thereto. On the contrary, various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A method for optimizing an operation of selecting suitable a network model used in an electronic device, the electronic device comprises a storage medium; the storage medium stores at least one command; the at least one command is implemented by a processor to execute:
identifying a category of an input content and selecting a training set based on the identified category in response to a processing command;
matching several network models as matched network models based on the identified category in response to a matching command;
acquiring performance data corresponding to the matched network models in response to an acquiring command;
selecting one of the matched network models as a test network model based on the performance data in response to a selection command;
inputting the input content and the selected training set into the test network model and outputting an output result in a display interface in response to a training command;
determining whether the output result is satisfactory in response to a determining command; and
executing an optimization operation when the output result is not satisfactory.

2. The method of claim 1, wherein the performance data can include a processing speed, an output result accuracy, and a size of the matched network model.

3. The method of claim 1, wherein the step of determining whether the output result is satisfactory in response to a determining command comprises:
selecting correct images in the output result;
calculating an accuracy of the output result; and
determining whether the degree of the accuracy is less than a preset value;
when the degree of the accuracy is less than the preset value, the output result is not satisfactory.

4. The method of claim 1, wherein the step of executing an optimization operation when the output result is not satisfactory comprises:
establishing an interface displaying several suggested optimization manners;
determining whether a first suggested optimization manner in the interface is selected; and
adjusting the structure of the test network model when the first suggested optimization manner is selected.

5. The method of claim 4, wherein the step of executing an optimization operation when the output result is not satisfactory comprises:
determining whether a second suggested optimization manner in the interface is selected when the first suggested optimization manner is not selected; and
when the second suggested optimization manner is selected, re-selecting the test network model.

6. A network model optimization apparatus comprises a storage medium and at least one processor; the storage medium stores at least one command; the at least one commands is implemented by the at least one processor to execute functions; the storage medium comprising:
a processing module, configured to identify a category of an input content and select a training set based on the identified category in response to a processing command;
a matching module, configured to match several network models as matched network models based on the identified category in response to a matching command;
an acquiring module, configured to acquire performance data corresponding to the matched network models in response to an acquiring command;
a selection module, configured to select one of the matched network models as a test network model based on the performance data in response to a selection command;
a training module, configured to input the input content and the selected training set into the test network model and output an output result in a display interface in response to a training command;
a determining module, configured to determine whether the output result is satisfactory in response to a determining command; and
an optimization module, configured to execute an optimization operation when the output result is not satisfactory.

7. The network model optimization apparatus of claim 6, wherein the performance data can include a processing speed, an output result accuracy, and a size of the matched network model.

8. The network model optimization apparatus of claim 6, wherein the determining module further select correct images in the output result, and calculates an accuracy of the output result; the determining module further determines whether the degree of the accuracy is less than a preset value; when the degree of the accuracy is less than the preset value, the determining module determines that the output result is not satisfactory.

9. The network model optimization apparatus of claim 7, wherein the optimization module further establishes an interface displaying several suggested optimization manners selection interface and determines whether a first suggested optimization manner in the interface is selected; when the first suggested optimization manner is selected, the structure of the test network model is adjusted.

10. The network model optimization apparatus of claim 9, wherein when the first suggested optimization manner is not selected, the optimization module determines whether a second suggested optimization manner in the interface is selected; when the second suggested optimization manner is selected, the selection module further re-selecting the test network model.

11. An electronic device comprises a storage medium and at least one processor; the storage medium stores at least one command; the at least one commands is implemented by the at least one processor to execute functions; the storage medium comprising:
identifying a category of an input content and selecting a training set based on the identified category in response to a processing command;
matching several network models as matched network models based on the identified category in response to a matching command;
acquiring performance data corresponding to the matched network models in response to an acquiring command;
selecting one of the matched network models as a test network model based on the performance data in response to a selection command;
inputting the input content and the selected training set into the test network model and outputting an output result in a display interface in response to a training command;
determining whether the output result is satisfactory in response to a determining command; and
executing an optimization operation when the output result is not satisfactory.

12. The electronic device of claim 11, wherein the performance data can include a processing speed, an output result accuracy, and a size of the matched network model.

13. The electronic device of claim 11, wherein the step of determining whether the output result is satisfactory in response to a determining command comprises:
selecting correct images in the output result;
calculating an accuracy of the output result; and
determining whether the degree of the accuracy is less than a preset value;
when the degree of the accuracy is less than the preset value, the output result is not satisfactory.

14. The electronic device of claim 11, wherein the step of executing an optimization operation when the output result is not satisfactory comprises:
establishing an interface displaying several suggested optimization manner selection interface;
determining whether a first suggested optimization manner in the interface is selected; and
adjusting the structure of the test network model when the first suggested optimization manner is selected.

15. The electronic device of claim 14, wherein the step of executing an optimization operation when the output result is not satisfactory comprises:
determining whether a second suggested optimization manner in the interface is selected when the first suggested optimization manner is not selected; and
when the second suggested optimization manner is selected, re-selecting the test network model.

16. A storage medium, the storage medium is a computer readable storage medium;
the storage medium stores at least one command; the at least one command is implemented by a processor to execute the following steps:
identifying a category of an input content and selecting a training set based on the identified category in response to a processing command;
matching several network models as matched network models based on the identified category in response to a matching command;
acquiring performance data corresponding to the matched network models in response to an acquiring command;
selecting one of the matched network models as a test network model based on the performance data in response to a selection command;
inputting the input content and the selected training set into the test network model and outputting an output result in a display interface in response to a training command;
determining whether the output result is satisfactory in response to a determining command; and
executing an optimization operation when the output result is not satisfactory.

17. The storage medium of claim 16, wherein the performance data can include a processing speed, an output result accuracy, and a size of the matched network model.

18. The storage medium of claim 16, wherein the step of determining whether the output result is satisfactory in response to a determining command comprises:
selecting correct images in the output result;
calculating an accuracy of the output result; and
determining whether the degree of the accuracy is less than a preset value;
when the degree of the accuracy is less than the preset value, the output result is not satisfactory.

19. The storage medium of claim 16, wherein the step of executing an optimization operation when the output result is not satisfactory comprises:
establishing an interface displaying several suggested optimization manner selection interface;
determining whether a first suggested optimization manner in the interface is selected; and
adjusting the structure of the test network model when the first suggested optimization manner is selected.

20. The storage medium of claim 19, wherein the step of executing an optimization operation when the output result is not satisfactory comprises:
determining whether a second suggested optimization manner in the interface is selected when the first suggested optimization manner is not selected; and
when the second suggested optimization manner is selected, re-selecting the test network model.
